(19) United States
(12) Patent Application Publication
(10) Pub. No.: US 2012/0118019 A1
(43) Pub. Date: May 17, 2012

(54) METHOD OF PRODUCING OPTICAL FIBER

(75) Inventors: Tadashi TAKAHASHI, Tokyo (JP); Taeko Shibuta, Tokyo (JP); Takeshi Yagi, Tokyo (JP)

(73) Assignee: FURUKAWA ELECTRIC CO., LTD., Chiyoda-ku (JP)

(21) Appl. No.: 13/293,605

(22) Filed: Nov. 10, 2011

(30) Foreign Application Priority Data
Nov. 12, 2010 (JP) 2010-254002

(51) Int. Cl. C03B 37/027; C03B 37/018

(52) U.S. Cl. 65/393

(57) ABSTRACT

A method of producing an optical fiber that has a hole extending in a longitudinal direction includes preparing a glass preform that has a hole extending in a longitudinal direction, synthesizing a porous preform layer by depositing silica-based glass particles on an outer circumference of the glass preform, dehydrating the porous preform layer, sintering the dehydrated porous preform layer under a reduced pressure so that the porous preform layer becomes a translucent glass preform layer that contains closed pores, and drawing a translucent glass preform that includes the glass preform and the translucent glass preform layer so that the translucent glass preform layer becomes a transparent glass layer.

### CROSS-REFERENCE TO RELATED APPLICATION

This application is based upon and claims the benefit of priority from the prior Japanese Patent Application No. 2010-254002, filed on Nov. 12, 2010; the entire contents of which are incorporated herein by reference.

### BACKGROUND OF THE INVENTION

1. Field of the Invention

The present invention relates to a method of producing an optical fiber having a plurality of holes extending in an axial direction.

2. Description of the Related Art

A typical optical fiber made of silica glass includes a core having a refractive index increased by, for example, being doped with germanium and also includes a cladding that surrounds the core and has a refractive index less than that of the core. Due to the effect of the total reflection of light that occurs at the boundary surface between the cladding and the core, light passes through within the core portion. Conventionally, the practicable relative refractive-index difference between the core and the cladding is no more than about 3% to 4%.

In contrast, recently, an optical fiber has been reported that has a relative refractive-index difference greater than that of a conventional optical fiber (see, for example, Japanese Patent Application Laid-open No. H10-95628). It is reported in Japanese Patent Application Laid-open No. H10-95628 that, by forming, in the cladding, a plurality of holes extending in the longitudinal direction, the average refractive index of the cladding is largely decreased. In other words, Such an optical fiber having holes has an effective relative refractive-index difference between the core and the cladding much greater than that of a conventional optical fiber.

Such an optical fiber having holes is produced by producing an optical fiber preform having holes and then heating and drawing it. Typical methods of forming holes on an optical fiber preform include a method of boring holes at predetermined positions on a solid glass preform by using a drill (see, for example, Japanese Patent Application Laid-open No. 2002-145634), a method of binding together a plurality of glass tubes and glass rods and then fusing the outer surfaces of the glass tubes and the glass rods together by heat in such a manner that the holes of the glass tubes remained (see, for example, Japanese Patent Application Laid-open No. H10-95628), or the like.

For such an optical fiber having holes formed therein, for the purpose of achieving desirable properties, it is preferable to have holes that are not deformed and are uniform over the entire length of the optical fiber in the longitudinal direction.

A method of producing an optical fiber preform with suppressed deformation of holes has been proposed that involves depositing glass particles on the outer circumference of a glass preform having a plurality of holes extending in the longitudinal direction, thereby forming a porous glass preform, and then sintering the porous glass preform, thereby producing an optical fiber preform having the holes extending in the longitudinal direction (see, Japanese Patent Application Laid-open No. 2004-244260).

### SUMMARY OF THE INVENTION

It is an object of the present invention to at least partially solve the problems in the conventional technology.

According to one aspect of the present invention, there is provided a method of producing an optical fiber that has a hole extending in a longitudinal direction, including preparing a glass preform that has a hole extending in a longitudinal direction, synthesizing a porous preform layer by depositing silica-based glass particles on an outer circumference of the glass preform, dehydrating the porous preform layer, sintering the dehydrated porous preform layer under a reduced pressure so that the porous preform layer becomes a translucent glass preform layer that contains closed pores, and drawing a translucent glass preform that includes the glass preform and the translucent glass preform layer so that the translucent glass preform layer becomes a transparent glass layer.

The above and other objects, features, advantages and technical and industrial significance of this invention will be better understood by reading the following detailed description of presently preferred embodiment of the invention, when considered in connection with the accompanying drawings.

### BRIEF DESCRIPTION OF THE DRAWINGS

FIG. 1 is a flowchart of a method of producing an optical fiber according to an embodiment;

FIGS. 2A and 2B are schematic diagrams that explain the preparation step;

FIG. 3 is a schematic diagram that explains the synthesis step;

FIG. 4 is an explanatory diagram of an electric furnace (dehydration/sintering furnace) that is used for the dehydration step and the sintering step;

FIG. 5 is a schematic diagram of a translucent optical fiber preform in which a porous preform layer is converted to a translucent glass preform layer;

FIG. 6 is a diagram that explains a drawing equipment that is used for the drawing step;

FIG. 7 is a table of dehydration/sintering conditions of Example 1;

FIG. 8 is a table of dehydration/sintering conditions of Example 2;

FIG. 9 is a table of dehydration/sintering conditions of Example 3;

FIG. 10 is a table of dehydration/sintering conditions of Example 4;

FIG. 11 is a table of dehydration/sintering conditions of Example 5; and

FIG. 12 is a table of dehydration/sintering conditions of Comparative example 1.

### DETAILED DESCRIPTION OF THE PREFERRED EMBODIMENTS

Exemplary embodiments of a method of producing an optical fiber according to the present invention are described in detail below with reference to the accompanying drawings. It should be noted that the invention is not limited to the following embodiments. The drawings are made with sufficient accuracy to understand the contents, and the shapes may be different from the actual shapes according to the actual scale size.

If the method described in Japanese Patent Application Laid-open No. 2004-244260 is used, when the porous glass preform is sintered, the holes formed on the glass preform may be deformed due to shrinkage of the glass preform that occurs when the porous glass layer is sintered and due to extension of the glass preform caused by its own weight when it is heated during sintering. This phenomenon becomes more prominent in larger optical fiber preforms. In other words, even if the method described in Japanese Patent Application Laid-open No. 2004-244260 is used, deformation of holes of an optical fiber preform and deformation of holes of an optical fiber that is produced by drawing the optical fiber preform still occur with respect to the respective longitudinal directions.

In contrast, according to an embodiment of the present invention, an optical fiber in which deformation of the holes in the longitudinal direction is suppressed is realized.

### Embodiment

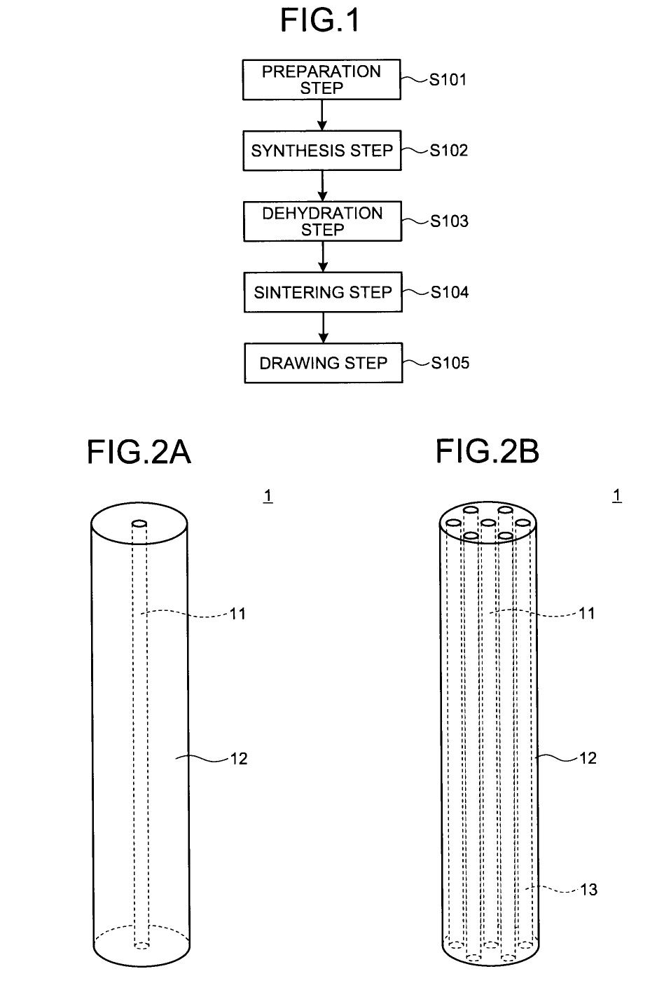

FIG. 1 is a flowchart of a method of producing an optical fiber according to an embodiment of the present invention.

The method of producing an optical fiber according to the present embodiment involves, as illustrated in FIG. 1, a preparation step of preparing a glass preform that has holes extending in the longitudinal direction (Step S101), then a synthesis step of depositing silica-based glass particles on the outer circumference of the prepared glass preform, thereby synthesizing a porous preform layer (Step S102), then a dehydration step of dehydrating the porous preform layer under conditions that satisfy at least any one of a reduced pressure, a mixture gas atmosphere that contains an inert gas and a halogen gas, and a mixture gas atmosphere that contains an inert gas and a gas of a halogen-based compound (Step S103), and then a sintering step of sintering the dehydrated porous preform layer under a reduced pressure so that the porous preform layer becomes a translucent glass preform layer that contains closed pores (Step S104). The method further involves a drawing step of drawing a semitransparent glass preform that includes the translucent glass preform layer containing closed pores so that the translucent glass preform layer becomes a transparent glass layer, thereby producing an optical fiber (S105).

The method of producing an optical fiber that involves the above steps enables production of an optical fiber that has holes with suppressed deformation in the longitudinal direction, while decreasing the consumed amount of expensive helium gas, prolonging the lifetime of the production equipment, and decreasing the number of necessary steps; therefore, the method enables reduction of the production costs of an optical fiber.

Each step is described more specifically below.

FIGS. 2A and 2B are schematic diagrams that explain the preparation step of Step S101 in which holes are formed by using a boring method.

The preparation step involves producing a glass preform that has holes extending in the longitudinal direction. Methods of producing a glass preform that has holes extending in the longitudinal direction include a method of binding together a plurality of glass tubes or a plurality of glass tubes and glass rods so that they are tightly packed and then integrating them together, and a method of boring holes on a cylindrical glass preform by a mechanical means, such as drilling.

In the following, a method will be explained of boring holes on a cylindrical glass preform, thereby producing a glass preform that has holes extending in the longitudinal direction.

Firstly, by using a well known method, such as a VAD (Vapor phase Axial Deposition) method, an OVD (Outside Vapor Deposition) method, or an MCVD (Modified Chemical Vapor Deposition) method, a cylindrical glass preform 1 made of silica glass is produced as illustrated in FIG. 2A.

The glass preform 1 includes a core 11 that is at a center portion and has a refractive index increased by being doped with Ge or the like, and also includes a cladding 12 that surrounds the core 11 and has a refractive index less than that of the core 11 that is made of pure silica glass or the like. The pure silica glass means silica glass that contains no refractive-index adjusting dopant. The amount of Ge or the like, used for doping can change depending on the required characteristics of the optical fiber. The glass preform 1 may include no core, i.e., the entire glass preform can be made of pure silica glass.

As illustrated in FIG. 2B, one or more holes 13 are bored on the cladding 12 of the glass preform 1 by using a mechanical means, such as drilling, in such a manner the holes 13 extend in the longitudinal direction of the glass preform 1. In this example, the holes 13 that are formed are six. The holes 13 may be formed on the core 11 or on both the core 11 and the cladding 12.

Subsequently, the inner surfaces of the formed holes 13 are cleaned and subjected to optical polish.

As described above, the glass preform 1 is produced that has the holes 13 extending in the longitudinal direction.

If, as described above, a glass preform having holes is produced by using the method of boring the holes 13 on the cylindrical glass preform 1 by using a mechanical means, such as drilling, there are advantages such as good operability and high positional accuracy of the holes when compared with the method of binding together a plurality of glass tubes or a plurality of glass tubes and glass rods so that they are tightly packed and then integrating them together, thereby producing a glass preform having holes. Especially if the number of the holes is twenty or less, the hole boring method is preferable. The present invention is not limited thereto. It is allowable to produce and prepare a glass preform having holes by binding together a plurality of glass tubes or a plurality of glass tubes and glass rods so that they are tightly packed and then integrating them together.

The diameter, the number, and the positions of the holes are decided depending on the required characteristics of the optical fiber.

It is allowable to add a stretch step after the hole boring and, after the glass preform having the holes is stretched and elongated, clean and optically polish the inner surfaces of the holes 13. When the holes 13 are bore by using a machinery means, if the depth of the holes to be bored is deep, the holes 13 may extend in slant lines because it is difficult to bore the holes in straight lines each parallel to the center axis of the glass preform 1. The depth achievable by boring is limited because of the equipments. By adding the stretch step, the holes 13 can be bored accurately when the length of the glass preform 1 is short and then the glass preform 1 is elongated, which enables production of a large optical fiber with an increased hole positional accuracy.

The synthesis step of Step S102 will be explained below. The synthesis step involves depositing silica-based glass particles on the outer circumference of the glass preform 1 that includes the core 11 aligned on the center axis and the holes 13 extending in the longitudinal direction, thereby forming a porous preform layer.

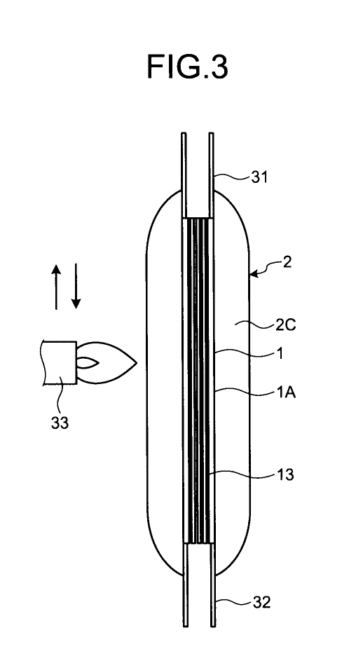

The VAD method and the OVD method can be used to form a porous preform layer. In the following, the OVD method is used. FIG. 3 is a schematic diagram that explains the synthesis step.

Before a porous preform layer is formed on the outer circumference of the glass preform 1, a tubular member 31 is joined to an end of the glass preform 1 in such a manner that a hollow portion of the tubular member 31 is in communication with the holes 13 so that every one of the holes 13 is open to the air. A supporting member 32 that supports the glass preform 1 is joined to the other end of the glass preform 1. The supporting member 32 that is joined to the other end may be either a tubular member as illustrated in FIG. 3 or a solid member. A solid member is preferable for securing the strength to support the glass preform 1. If the supporting member 32 is a tubular member and both ends of every one of the holes 13 are open to the air, because such a configuration allows an atmosphere gas to pass through the holes 13, deformation of the holes 13 caused by heat is suppressed more.

The glass preform 1 that has the holes 13 and that is joined to the tubular member 31 and the supporting member 32 is called “target rod 1A”.

The target rod 1A is axially supported by an OVD-based producing apparatus in such a manner that a not-illustrated holding mechanism of the producing apparatus holds one end at the supporting member 32 and the other end at the tubular member 31. A not-illustrated driving mechanism of the producing apparatus rotates the target rod 1A at a predetermined speed. The driving mechanism moves a glass particle synthesis burner 33 back and forth along the axial direction of the rotating target rod 1A.

The glass particle synthesis burner 33 is supplied with a glass material gas of SiCl₄ gas and combustion gases that include H₂ gas and O₂ gas, and flame-hydrolyzes the glass material gas by a flame that is produced by the combustion gases, thereby synthesizing glass particles. The synthesized glass particles are sprayed from the glass particle synthesis burner 33 onto the outer circumference of the rotating target rod 1A and thus a glass-particle deposit layer is formed. Thereby, a porous preform layer 2C is formed. As described above, a glass preform 2 that includes the porous preform layer 2C (hereinafter, “porous glass preform 2”) is produced.

The average density of the porous preform layer 2C (that is calculated by subtracting the weight of the target rod 1A from the total weight of the porous glass preform 2, thereby calculating the weight of the porous preform layer 2C, then subtracting the volume of the target rod 1A from the total volume of the porous glass preform 2, thereby calculating the volume of the porous preform layer 2C, and then dividing the weight of the porous preform layer 2C by the volume of the porous preform layer 2C) is preferably a value from 0.5 g/cm³ to 0.9 g/cm³ from the perspective of reducing the degree of shrinkage of the preform occurring during the dehydration step and the sintering step that will be described later, thereby suppressing deformation of the holes.

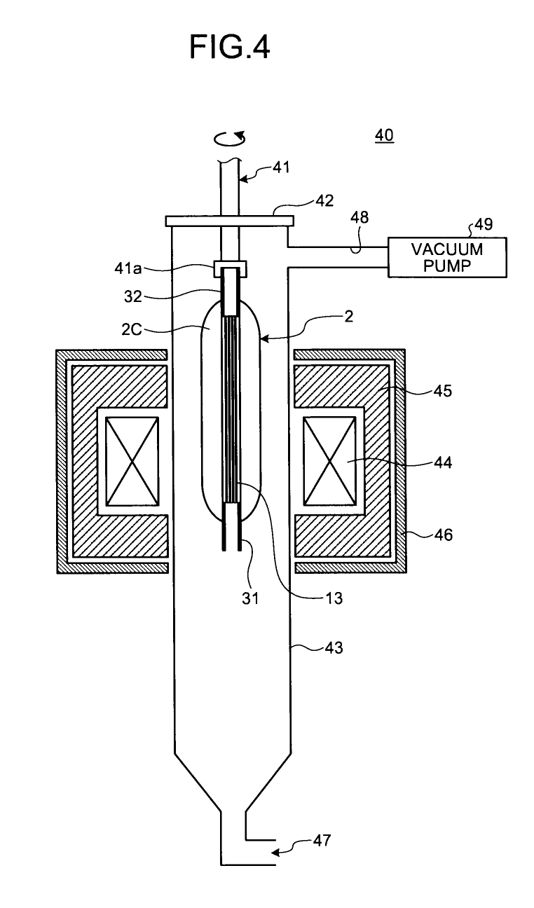

The dehydration step of Step S103 and the sintering step of Step S104 will be explained below. FIG. 4 is an explanatory diagram of an electric furnace (dehydration/sintering furnace) 40 that is used for the dehydration step and the sintering step.

The dehydration/sintering furnace 40 includes a rotating-and-moving-up/down mechanism 41 that has a holder 41a for holding the porous glass preform 2; a silica-glass-made core tube 43 that accommodates therein the porous glass preform 2; an upper lid 42 of the core tube 43; a circular multi-heater 44 that surrounds the outer circumference of the core tube 43 and that heats the porous glass preform 2 from outside; and a furnace body 46 that surrounds the outer circumference of the core tube 43 and that accommodates therein the heater 44 in such manner that a heat insulator 45 is between the furnace body 46 and the heater 44.

The core tube 43 further includes a gas supply port 47 on a lower section through which an inert gas, such as helium gas, and an inert gas that contains chlorine gas are supplied into the core tube 43 and a gas ejecting port 48 on an upper section through which used gases are ejected from the core tube 43.

The method of converting the porous preform layer 2C into a translucent glass preform layer that contains closed pores each having a substantially vacuum inside by using the dehydration/sintering furnace 40 involves holding the supporting member 32 that is joined to the porous glass preform 2 with the holder 41a of the rotating-and-moving-up/down mechanism 41 and then putting the porous glass preform 2 inside the silica core tube 43.

The tubular member 31 is still joined to either or both ends of the porous glass preform 2 in the same manner as it is at the synthesis step. The hollow portion of the tubular member 31 is still in communication with the holes 13, and every one of the holes 13 is still open to the air.

During the dehydration step (S103), the pressure on the inside of the silica core tube 43 is maintained to be a predetermined value by supplying a predetermined amount of chlorine gas (Cl₂) and a predetermined amount of nitrogen gas (N₂) from the gas supply port 47 and ejecting an appropriate amount of gas from the gas ejecting port 48.

The dehydration step is not limited to the above. The dehydration step is conducted at a temperature equal to or lower than 1300° C. under the conditions that satisfy at least any one of a reduced pressure, a mixture gas atmosphere that contains an inert gas and a halogen gas, and a mixture gas atmosphere that contains an inert gas and a gas of a halogen-based compound. The gas of a halogen-based compound can be, for example, thionyl chloride (SOCl₂) or the like. For short-time and sufficient dehydration, the processing temperature of the dehydration step is preferably 1000° C. or higher.

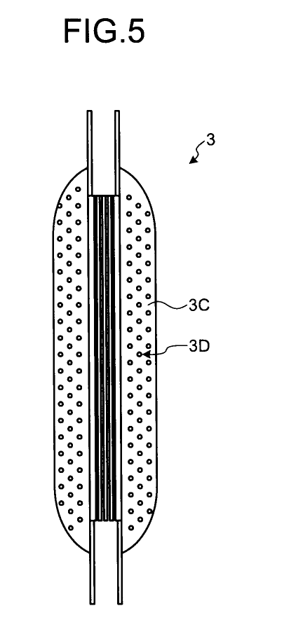

The silica core tube 43 is connected to a vacuum pump 49 and, at the subsequent sintering step (S104), the pressure on the inside is decreased by using the vacuum pump 49. The porous preform layer 2C becomes, after it is subjected to the dehydration process and the sintering process inside the silica core tube 43, a translucent glass preform layer that is translucent glass and contains closed pores each having a substantially vacuum inside. The glass preform 1 that includes the translucent glass preform layer is called “translucent optical fiber preform”. FIG. 5 is a schematic diagram of a translucent optical fiber preform 3 in which the porous preform layer 2C is converted to a translucent glass preform layer 3C. The translucent glass preform layer 3C contains closed pores 3D that are distributed substantially uniformly over the entire, and it appears to be cloudy and opaque. The surface is smooth and glossy.

The “translucent glass status” means, herein, that the status of containing closed pores distributed substantially uniformly over the entire and appearing to be cloudy and opaque. In contrast, the “transparent glass status” means that less closed pores are found in a defective section that is a part of the glass layer but, except the defective section, no closed pores are found and it appears to be transparent. The “closed pores” mean, herein, pores or spaces that are formed in the translucent glass preform layer and physically separated from the ambient atmosphere. The “vacuum” means, as defined in JIS Z 8126 “a status of a particular space filled with gas whose pressure is less than the atmospheric pressure”.

The rate at which the sintering progresses changes depending on the conditions, such as the temperature, the time, and the diameter and the composition of glass particles. The rate at which the sintering progresses is likely to increase as it comes closer to the surface of the porous preform layer 2C. With various experiments of dehydrating/sintering the porous preform layer 2C at different temperatures and for different heating times, it is found that, to make the translucent glass preform layer 3C a status of containing the closed pores 3D that are substantially separated from the ambient atmosphere, the average density of translucent glass preform layer 3C after the sintering is preferably equal to or greater than 1.8 g/cm³, more preferably, equal to or greater than 2.0 g/cm³. Because the density of completely transparent silica glass is 2.2 g/cm³, the average density of the translucent glass preform layer 3C after the sintering needs to be a value less than 2.2 g/cm³.

From the perspective that no pores remain at the subsequent drawing step, the reduced pressure under which the sintering step is conducted has an upper limit. In order to cause, at the subsequent drawing step, residual gas in the closed pores 3D to pass through the silica glass and go outside, i.e., no pores remain inside, the total amount of residual gas in the closed pores 3D needs to be a value equal to or less than the saturated solubility of the gas into the silica glass at the drawing temperature. If the residual gas is, for example, nitrogen gas (N₂), a solubility S of N₂ in silica glass at an atmosphere temperature T is calculated by referring to “Advances in the fusion and processing of glass 2nd” G. C. Beerkens, 1990 Vol 63K, pp 222-242, or the like.

With the calculated relation between the pressure during the sintering step and the density of the translucent glass preform layer that prevents, at the drawing step, pores from remaining inside and results of various experiments conducted under various conditions, it is found that when the average density of the translucent glass preform layer 3C is equal to or greater than 2.13 g/cm³, every pore is a closed pore. To produce an optical fiber having no remaining pores, it is found that the pressure during the sintering step is preferably equal to or less than 2000 Pa, and to reduce remaining pores to the least possibly at the drawing step, the pressure is, more preferably, equal to or less than 1000 Pa.

Moreover, to suppress deformation of the holes 13 with respect to the longitudinal direction, the processing temperature of the sintering step is preferably equal to or lower than 1450° C. To further suppress deformation of the holes 13, the temperature is, more preferably, equal to or lower than 1400° C.

Furthermore, for sufficient sintering at a short-time, i.e., for achievement of the status of translucent glass that enables production of an optical fiber having no remaining pores, the processing temperature is preferably equal to or higher than 1300° C.

The drawing step of Step S105 will be explained below. The drawing step involves drawing the produced translucent optical fiber preform 3 as it is. During the drawing step, the bonding between the particles of the translucent glass preform layer 3C is increased by the heat, the density is increased because the pores are reduced, and the translucent glass finally becomes transparent glass that contains no pores.

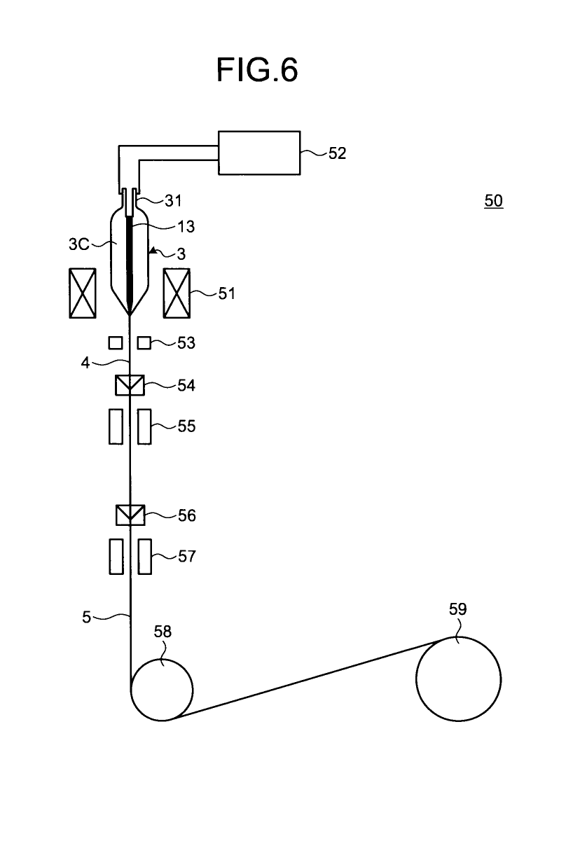

FIG. 6 is a diagram that explains a drawing equipment that is used for the drawing step according to the present embodiment.

Firstly, the translucent optical fiber preform 3 is arranged inside of an electric furnace (drawing furnace) of a drawing equipment 50, then an end of the translucent optical fiber preform 3 is fused by the heat of a heater 51 that is inside the drawing furnace and then drawn in the vertically downward direction, thus a glass optical fiber 4 is produced. The tubular member 31 is still joined to the upper end of the translucent optical fiber preform 3 in the same manner as it is at the sintering step. The hollow portion of the tubular member 31 is still in communication with the holes 13 and every one of the holes 13 is open to the air.

It is allowable to replace the tubular member 31 before the drawing step; however, the continuous use of the same tubular member 31 over the synthesis step, the dehydration step, and the sintering step makes the step of replacing the tubular member 31 unnecessary and enables easier production of an optical fiber having holes.

A hole pressure device 52 is joined to the upper end of the translucent optical fiber preform 3 via the tubular member 31. By sending an inert gas, such as N₂ and Ar, from the hole pressure device 52 into the holes 13 of the translucent optical fiber preform 3, the pressure on the inside of the holes 13 is increased. With this configuration, the optical fiber is drawn without the holes 13 crushed.

Then, after the glass optical fiber 4 is fused by the heat and then drawn, while the outer diameter of the glass optical fiber 4 is monitored by using an outer-diameter measuring device 53, an ultraviolet curable resin is applied to the outer circumferential surface of the glass optical fiber 4 by using a coating device 54. After that, the applied ultraviolet curable resin is exposed to ultraviolet irradiation from an ultraviolet irradiating device 55 and hardened and thus a primary coating layer is formed. Then, an ultraviolet curable resin is further applied to the primary coating layer by using a coating device 56. After that, the applied ultraviolet curable resin is exposed to ultraviolet irradiation from an ultraviolet irradiating device 57 and hardened and thus a secondary coating layer is formed to making an optical fiber 5 which is coated. It is allowable to provide a not-illustrated outer-diameter measuring device at the position after each ultraviolet curable resin is applied. The number of formed coating layers is adjustable depending on the purpose for which the optical fiber 5 will be used. The number of coating devices, the ultraviolet irradiating devices, and the outer-diameter measuring devices is decided in accordance with the number of coating layers. It is allowable to use a method of applying a plurality of coating layers at the same time and then hardening the coating layers.

After that, a guide roller 58 leads the optical fiber 5 to a winder 59 and the winder 59 winds the optical fiber 5 onto a bobbin. The optical fiber 5 is thus produced.

A conventional method, used at the dehydration/sintering step, of converting the porous preform layer 2C to a completely transparent layer involves heating the porous glass preform 2 at a temperature equal to or lower than 1300° C. where the sintering do not progress, thereby sufficiently dehydrating the porous glass preform 2, then exposing the porous glass preform 2 to a high temperature condition about 1500° C., thereby sintering the porous glass preform 2 and converting it into a transparent layer. When the sintering step is conducted according to this method, i.e., the porous glass preform 2 is exposed to a high temperature condition about 1500° C., the length of the porous glass preform 2 is decreased due to shrinkage and also the phenomenon of extension by its own weight occurs; therefore, after the sintering step, change occurs in the outer diameter of the transparent optical fiber preform and change also occurs in the inner diameter of the holes formed inside.

In contrast, the present embodiment uses the method of sintering, after the dehydration step, the porous preform layer 2C under a reduced pressure at a temperature within such a range that a translucent glass layer is formed. When the sintering is conducted at a temperature within such a range that a translucent glass layer is formed, the degree of shrinkage of the porous glass preform 2 caused by the sintering is smaller than the degree of shrinkage of the porous glass preform 2 when a completely transparent glass layer is formed. Moreover, because the processing temperature is lower than the conventional processing temperature, almost no extension occurs by its own weight. Therefore, change is suppressed in the outer diameter of the formed translucent optical fiber preform 3 and change is also suppressed in the inner diameter of the holes 13 formed inside.

Therefore, by drawing the translucent optical fiber preform 3 produced according to the present embodiment, the optical fiber 5 that is produced has the holes 13 with suppressed deformation in the longitudinal direction.

Because the amount of change in the outer diameter after the sintering of the porous glass preform is likely to increase in larger optical fiber preforms, the effect of suppressing the deformation of the holes in the longitudinal direction becomes particularly notable when the weight of the optical fiber preform is equal to or larger than 10 kg.

Moreover, in the present embodiment, because the sintering step is conducted under a reduced pressure, the consumed amount of expensive helium gas is reduced. Furthermore, because the processing temperature is lower than the conventional processing temperature, damage on a core tube of the dehydration/sintering furnace 40 is reduced and its lifetime is increased. As described above, the production costs are reduced, such as the cost of energy for heating and the equipment maintenance cost.

Although, in the present embodiment, single dehydration step and then single sintering step are conducted step by step, i.e., a translucent glass preform layer is formed after the two steps in total, it is allowable to conduct two or more dehydration steps and two or more sintering steps. Moreover, it is allowable to add, between the dehydration step and the sintering step, a plurality of middle steps in which the temperature is set to a value between the temperature of the dehydration step and the temperature of the sintering step.

The present invention will be explained more specifically with reference to Examples and Comparative example. The present invention is not limited to Examples and Comparative example.

Firstly, a glass preform having holes formed thereon was produced according to the above embodiment.

Firstly, by using the VAD method, a glass preform was produced that includes a core doped with Ge and a pure-silica-glass-made cladding that was on the outer circumference of the core. The ratio of the outer diameter of the core to the outer diameter of the cladding was about 1:5. Six holes were pored on the produced glass preform in such a manner that the holes surrounded the outer circumference of the core and extend in the longitudinal direction, and then the glass preform was heated and stretched so that its outer diameter became 40 mm and its length became 1000 mm.

The drilled holes were then cleaned and polished.

Then, a tubular member was joined to an end of the glass preform in such a manner that the hollow portion of the tubular member was in communication with the holes so that every hole was open to the air. A supporting member was joined to the other end of the glass preform to support the glass preform. A target rod was thus produced.

Then, each of the tubular member and the supporting member, which were joined to the ends, are held, and a glass particle synthesis burner was moved along the target rod back and forth in the axial direction, and thereby, glass particles were deposited on the outer circumference of the target rod. A porous glass preform that had the target rod and the porous preform layer formed on the outer circumference was thus produced. The porous glass preform had an outer diameter of 300 mm.

The average density of the porous preform layer was about 0.7 g/cm³, and the weight of the porous glass preform was 25 kg.

Subsequently, the porous glass preform was dehydrated and sintered by using the dehydration/sintering furnace illustrated in FIG. 4 under various conditions.

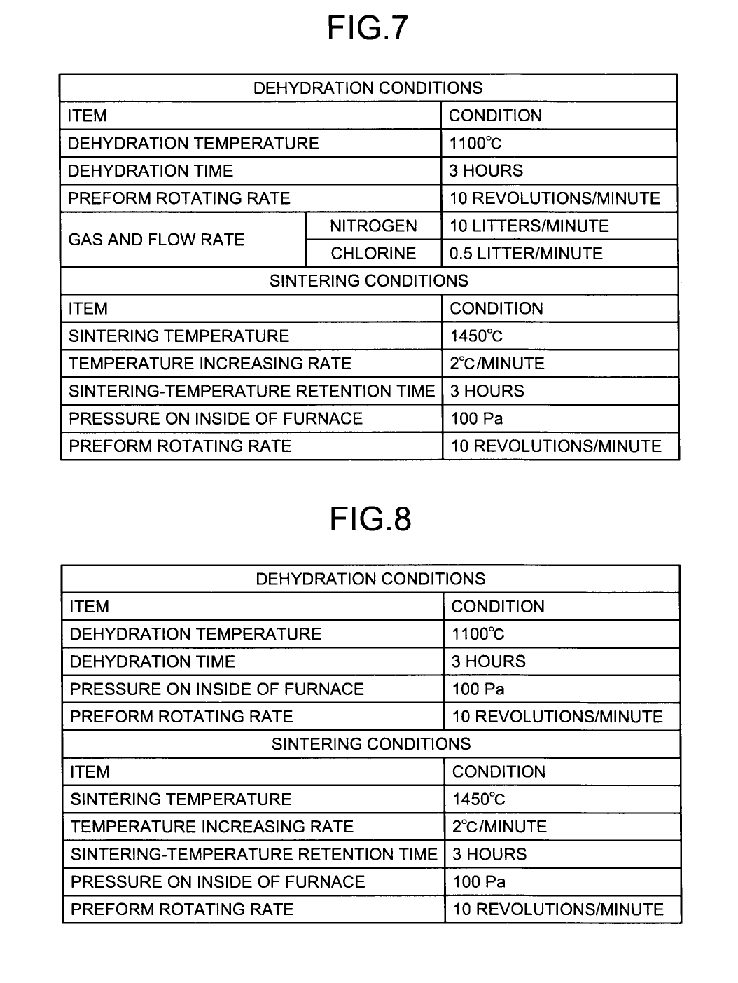

In Example 1, the porous glass preform 2 ware dehydrated and sintered under the conditions listed in FIG. 7 and, thereby, the porous preform layer was converted into a translucent glass preform layer that contained closed pores each having a substantially vacuum inside, and thus a translucent glass preform was produced.

At the end of the dehydration process and the sintering process, the translucent glass preform layer became a translucent glass that contained closed pores physically separated from the ambient atmosphere. The translucent glass preform contained the closed pores that were pores physically separated from the ambient atmosphere uniformly over the entire and it appeared to be cloudy and opaque. Its surface was smooth and glossy. The density of the translucent glass preform layer was 2.09 g/cm³ or 95% of the density of completely transparent glass (2.2 g/cm³).

In Example 2, the porous glass preform that was produced in the same manner as in Example 1 was dehydrated and sintered under the conditions listed in FIG. 8, and the porous preform layer was converted into a translucent glass preform layer that contained closed pores each having a substantially vacuum inside.

In Example 2, the pressure on the inside of the core tube was reduced even during the dehydration step.

At this stage, the translucent glass preform layer became a translucent glass in the same manner as in Example 1. The average density of the translucent glass preform layer was 2.1 g/cm³ or 95% of the density of completely transparent glass (2.2 g/cm³).

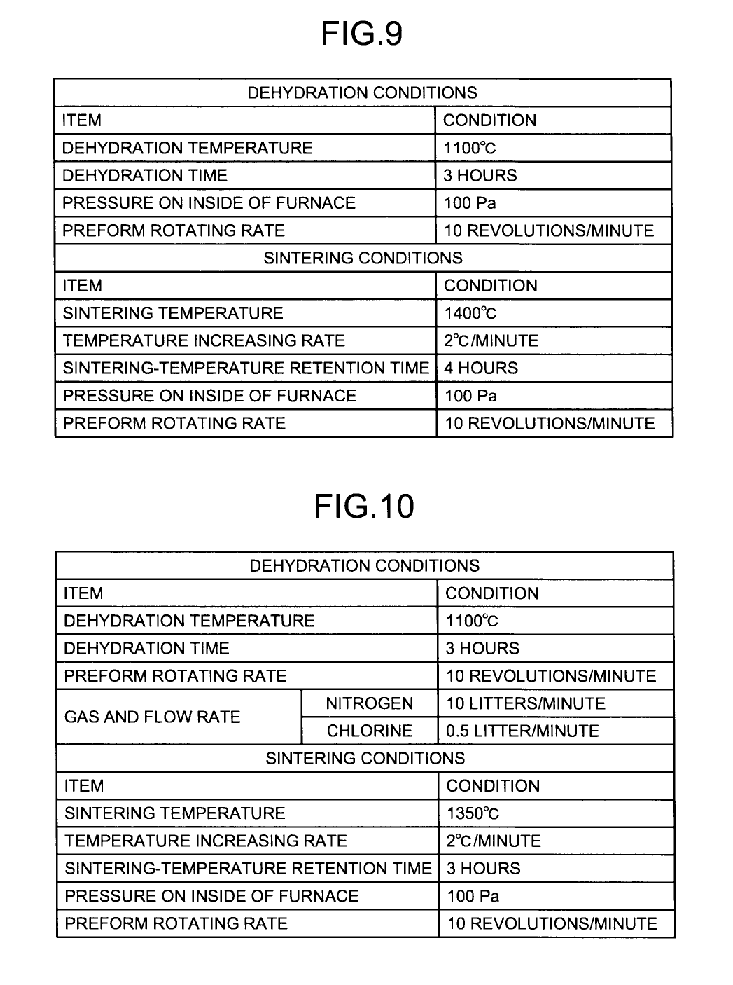

In Example 3, the porous glass preform that was produced in the same manner as in Example 1 is dehydrated and sintered under the conditions listed in FIG. 9, and the porous preform layer was converted into a translucent glass preform layer that contained closed pores each having a substantially vacuum inside.

In Example 3, the pressure on the inside of the core tube was reduced even during the dehydration step.

At this stage, the translucent glass preform layer became a translucent glass in the same manner as in Example 1. The average density of the semitransparent preform layer was 2.0 g/cm³ or 91% of the density of completely transparent glass (2.2 g/cm³).

In Example 4, the porous glass preform that was produced in the same manner as in Example 1 was dehydrated and sintered under the conditions listed in FIG. 10, and the porous preform layer was converted into a translucent glass preform layer that contained closed pores each having a substantially vacuum inside.

In Example 4, the pressure on the inside of the core tube was reduced only during the sintering step.

At this stage, the translucent glass preform layer became a translucent glass in the same manner as in Example 1. The average density of the translucent glass preform layer was 1.8 g/cm³ or 82% of the density of completely transparent glass (2.2 g/cm³).

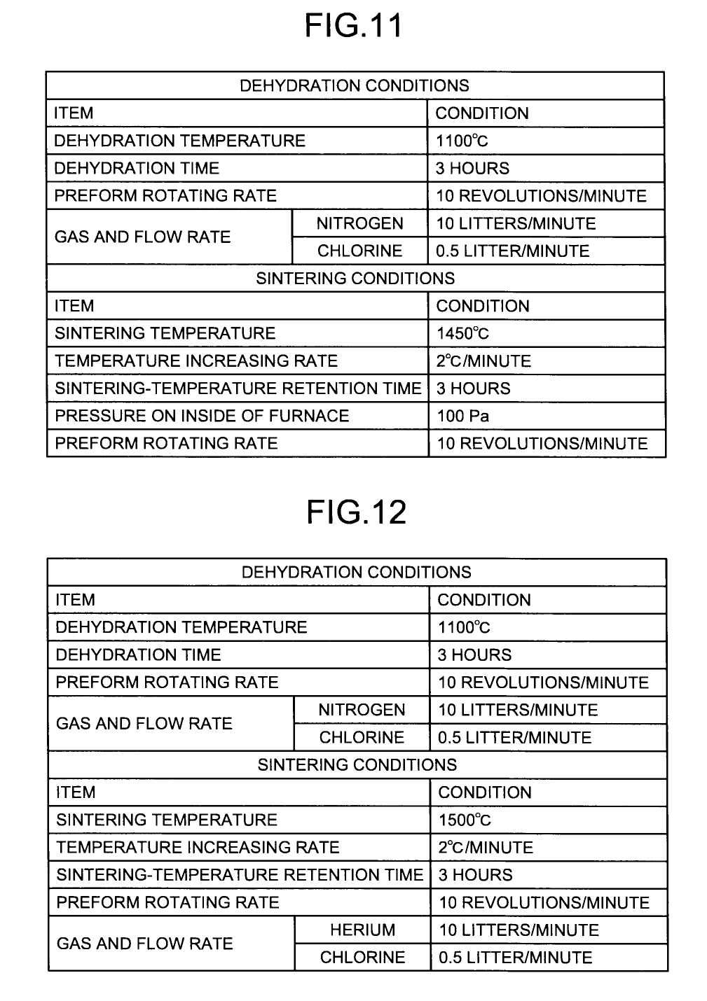

In Example 5, the porous glass preform that was produced in the same manner as in Example 1 is dehydrated and sintered under the conditions listed in FIG. 11, and the porous preform layer was converted into a translucent glass preform layer that contained closed pores each having a substantially vacuum inside.

In Example 5, the pressure on the inside of the core tube was reduced only during the sintering step.

At this stage, the translucent glass preform layer became a translucent glass in the same manner as in Example 1. The average density of the semitransparent preform layer was 2.1 g/cm³ or 95% of the density of completely transparent glass (2.2 g/cm³).

In Comparative example 1, the porous glass preform that was produced in the same manner as in Example 1 was dehydrated and sintered under the conditions listed in FIG. 12, and the porous preform layer was converted into a completely transparent preform.

In Comparative example 1, the pressure on the inside of the core tube was not reduced during either the dehydration step or the sintering step. Helium gas was used for the sintering step as an inert gas.

At this stage, the average density of the porous preform layer to be made completely transparent (transparent glass preform layer) was substantially equal to the density of completely transparent glass (2.2 g/cm³).

Then, the translucent optical fiber preforms produced in Examples 1 to 5 and the transparent optical fiber preform produced in Comparative example 1 were drawn according to the abovementioned embodiment. During the drawing, each optical fiber preform still had the tubular member joined to the end on which the holes were formed in the same manner as at the sintering step. The hollow portion of the tubular member was still in communication with the holes and every hole was still open to the air.

A hole pressure device was joined to the upper end of each optical fiber preform via the tubular member. The hole pressure device sended N₂ into the holes of the corresponding optical fiber preform, thereby increasing the pressure on the inside of the holes. The drawing speed of this example was 300 m/minute

The produced optical fibers were separated every 25 km, and the diameters of the holes on each edge surface were observed.

(Dl−Ds)/Da×100 was calculated, where Da is the average of all the observed diameters of the holes (6 holes×observation points), Ds is the minimum diameter, and Dl is the maximum diameter.

It was found that, the percentage of change in the hole diameter of any of the optical fibers of Examples 1 to 5 was small and equal to or less than 10%, especially, the percentages of change in Examples 3 and 4, where the sintering temperature was equal to or lower than 1400° C., were excellent and equal to or less than 5%. In contrast, the percentage of change in the hole diameter of Comparative example 1 was large and equal to or greater than 20%.

According to the present invention, a method is provided of producing an optical fiber having holes with suppressed deformation in the longitudinal direction.

Although the invention has been described with respect to specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of producing an optical fiber that has a hole extending in a longitudinal direction, the method comprising:
preparing a glass preform that has a hole extending in a longitudinal direction;
synthesizing a porous preform layer by depositing silica-based glass particles on an outer circumference of the glass preform;
dehydrating the porous preform layer;
sintering the dehydrated porous preform layer under a reduced pressure so that the porous preform layer becomes a translucent glass preform layer that contains closed pores; and
drawing a translucent glass preform that includes the glass preform and the translucent glass preform layer so that the translucent glass preform layer becomes a transparent glass layer.

2. The method according to claim 1, wherein each of the closed pores contained in the translucent glass preform layer has a substantially vacuum inside.

3. The method according to claim 1, wherein the sintering is conducted under such a condition that an average density of the porous preform layer becomes a value equal to or greater than 1.8 grams per cubic centimeter and less than 2.2 grams per cubic centimeter.

4. The method according to claim 1, wherein the sintering is conducted at a temperature equal to or lower than 1400 degrees centigrade.

5. The method according to claim 1, wherein the reduced pressure under which the sintering is conducted is a pressure equal to or less than 2000 pascals.

6. The method according to claim 1, wherein the dehydrating is conducted at a temperature equal to or lower than 1300 degrees centigrade under a condition that satisfies at least any one of a reduced pressure, a mixture gas atmosphere that contains an inert gas and a halogen gas, and a mixture gas atmosphere that contains an inert gas and a gas of a halogen-based compound.
